(19) United States
(12) Patent Application Publication
(10) Pub. No.: US 2006/0002482 A1
(43) Pub. Date: Jan. 5, 2006

(54) Signal drive de-emphasis for memory bus

(76) Inventors: Clinton Walker, Portland, OR (US); Rajeev Gopalan, Folsom, CA (US); Rebecca Loop, Portland, OR (US); Navneet Dour, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/883,613

(22) Filed: Jun. 30, 2004

(51) Int. Cl. H04B 3/00

(52) U.S. Cl. 375/257

(57) ABSTRACT

Apparatus and method to vary the strength with which a signal transmitted by a driver circuit of a transmitting device to a receiving circuit across a conductor such that a transmitted voltage level is driven onto a conductor with a reduced strength where adjacent binary bits values are of the same value so as to avoid building up capacitive a charge of either an undesirably high or undesirably low voltage level as a result of continuing to drive the same voltage level with the same strength, and such that a transmitted voltage level is driven onto a conductor with a greater strength where the voltage level now being transmitted differs from the previous voltage level so as to overcome the capacitive charge of the previous voltage level that may have built up, more quickly.

### BACKGROUND

In efforts to achieve ever greater processing performance in digital electronic systems, such as computer systems, both the quantity of random access memory (RAM) and the speed at which data is transferred to and from RAM have continued to be increased. Increasing quantities of memory often entails increasing the number of memory devices connected to conductors across which data is transferred to and from memory, thereby increasing capacitance levels and slowing down the rate at which changes in voltage levels to signal changes in binary values are able to propagate from one portion of each conductor to another. In earlier years, with slower data transfer rates, such added capacitance could be largely ignored, since there was plenty of time allowed for such propagation of a change in a signal to travel the full length of a conductor such that the entire conductor would achieve the new desired voltage level with time to spare before the voltage level received by a memory device located at some point along the conductor would latch the voltage level.

However, in the current day, data transfer rates have already become high enough that the amount of time required for such propagations of changes in signals along a conductor have now become significant quantities of time that can no longer be ignored and must, therefore, be reduced to allow data transfer rates to increase further. Various techniques have already been tried in an effort to address this issue, including the use of lower voltage swings (i.e., decreasing the difference between voltage levels signaling high and low binary values), differential signaling, and point-to-point interconnects in which multiple memory devices incorporate buffers through which signals are passed on to other memory devices in something of a “daisy chain” configuration. Unfortunately, the need for the voltage level that represents the binary value of 0 be distinguishable by receiving circuitry from the voltage level that represents the binary value of 1 limits the degree to which the difference between those two voltage levels may be reduced. Also, the use of differential signaling often doubles the number of signal conductors to be routed on a PCB between devices and/or the number of I/O pins required by each device to support such signaling. Furthermore, the use of point-to-point interconnects can both double the number of I/O pins required by each device and introduce a high amount of undesirable additional delay as a binary value is transmitted, received and then retransmitted between devices before reaching the device to which the binary value is directed, thus making the use of a configuration in which multiple devices are all coupled to the same conductor more appealing.

Therefore, there continues to be a need for a way to transfer data between devices (such as memory devices) across a plurality of conductors, where each conductor is attached to multiple devices, that further counteracts the delays on the propagation of changes in signals induced by the added capacitance levels caused by the attachment of those multiple devices, as well as capacitance induced by other factors, such as the relatively lengthy nature of the conductors to make possible the attachment of those multiple devices to each of the conductors.

### BRIEF DESCRIPTION OF THE DRAWINGS

The objects, features, and advantages of the present invention will be apparent to one skilled in the art in view of the following detailed description in which:

FIGS. 1a and 1b are a block diagram and corresponding perspective diagram, respectively, of embodiments employing a plurality of driver circuits.

FIG. 2 is a timing diagram of embodiments employing de-emphasis of the strength with which one or the other of two voltage levels is driven.

FIGS. 3a, 3b and 3c depict embodiments employing differing implementations of a driver circuit.

FIG. 4 is a flow chart of embodiments in which the strength by which a voltage level is driven onto a conductor is varied.

FIG. 5 is a block diagram of an embodiment employing a computer system.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

Embodiments of the present invention concern incorporating support within an electronic system, such as a computer system, for de-emphasizing the signal drive power employed in driving digital signals representing binary values between devices where the transmission of a signal representing a given binary value across a conductor is immediately followed by the continued transmission of the same signal representing the transmission of another instance of the same binary value to prevent driving the voltage level of the conductor with more power than necessary to aid in avoiding driving the voltage level on that conductor to a higher or lower level than is desirable. Although at least part of the following discussion centers on the driving of digital signals in memory systems within computer systems, it will be understood that embodiments of the claimed invention may be practiced in support of a number of different types of electronic devices employing the transmission of digital signals for any of a number of purposes.

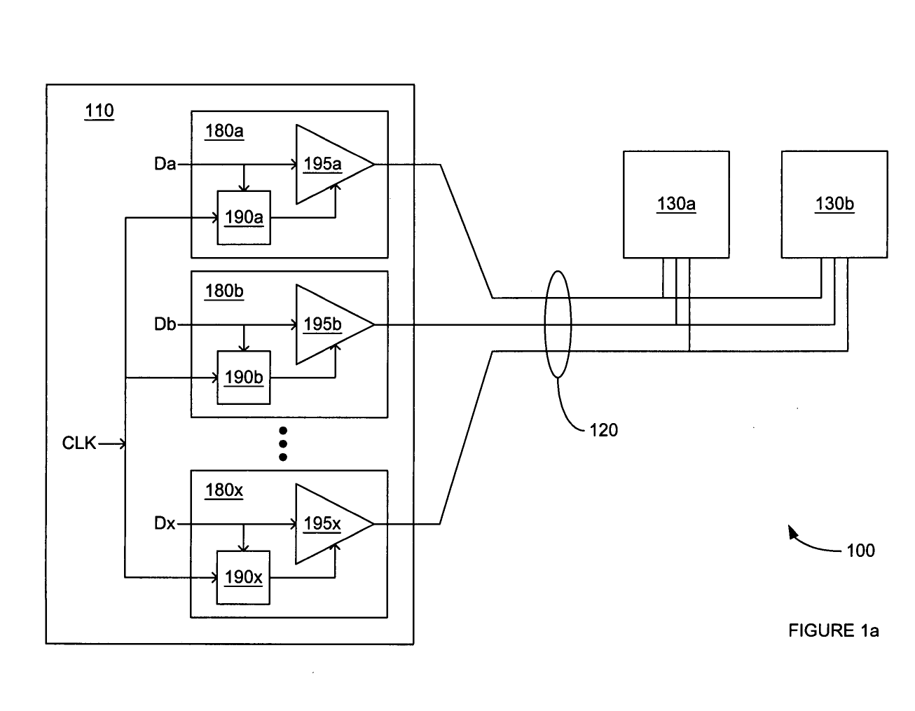

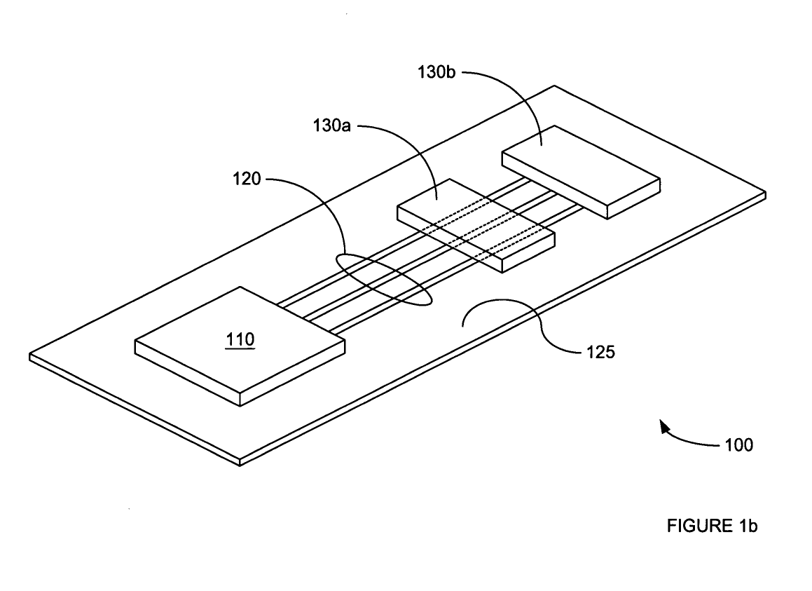

FIGS. 1a and 1b are a block diagram and corresponding perspective diagram, respectively, of embodiments employing a plurality of driver circuits. Electronic system 100 is, at least in part, made up of transmitting device 110, conductors 120, and receiving devices 130a and 130b. In some embodiments, conductors 120 may be implemented as conductive traces making up part of printed circuit board (PCB) 125, while in other embodiments, conductors 120 may be at least partially implemented as conductors within a multi-conductor cable (not shown).

In some embodiments, electronic system 100 may be a portion of a memory system within a computer system or other device incorporating a memory system, with transmitting device 110 being either a portion of or coupled to a memory controller, and conductors 120 making up at least part of a memory bus coupling transmitting device 110 to receiving devices 130a and 130b, with receiving devices 130a and 130b being either portions of or coupled to data storage devices, such as dynamic random access memory (DRAM) devices. In other embodiments, transmitting device 110 and receiving devices 130a and 130b may be portions of and/or coupled to various different devices, including I/O devices, with conductors 120 making up at least part of a more general purpose form of a bus coupling transmitting device 110 to both receiving devices 130a and 130b.

With conductors 120 coupling together three devices, as depicted in FIGS. 1a-b, conductors 120 may be described as making up a “multi-drop” bus, as opposed to what may be described as a “point-to-point” interconnect coupling together only two devices. The depiction of three devices coupled by conductors 120 should be taken only as illustrating a situation in which conductors 120 are subjected to a considerable capacitive load as a result of being coupled to multiple devices. However, those skilled in the art will readily recognize that conductors 120 may be subjected to considerable capacitive loads as a result of other factors beyond the number of devices coupled to conductors 120, including the length and cross section of conductors 120. Therefore, this depiction of conductors 120 to three devices should in no way be taken as limiting the spirit and scope of the present invention as hereinafter claimed to any one configuration, including “multi-drop” and “point-to-point” configurations.

Transmitting device 110 is made up, at least in part, of a plurality of driver circuits 180a, 180b and onward to 180x (the exact quantity of the plurality of driver circuits being immaterial to the practice of the claimed invention, as those skilled in the art will readily appreciate). Each one of driver circuits 180a-x are made up, at least in part, of one each of drivers 195a-x and controllers 190a-x, respectively. Each of driver circuits 180a-x receives a corresponding bit of binary data Da-x and drives voltage levels onto and across a corresponding one of conductors 120 to both receiving devices 130a and 130b.

Within each of driver circuits 180a-x, drivers 195a-x carry out the actual driving of voltage levels onto and across corresponding ones of conductors 120 in response to the binary 1 or 0 bit values being received as single bits of binary data Da-x at inputs to each of driver circuits 180a-x. In some embodiments, drivers 195a-x may drive a high voltage level in response to the receipt of a binary 1 value as a corresponding one of binary data Da-x, and a low voltage level (perhaps close to a ground level voltage) in response to the receipt of a binary 0 value, while in other embodiments, the correspondence between binary 1 and 0 values, and high and low voltage levels may be reversed.

Within each of driver circuits 180a-x, controllers 190a-x at least monitor corresponding inputs receiving corresponding binary data Da-x. In some embodiments, each one of controllers 190a-x stores the last binary bit value received for purposes of comparing that last binary bit value to the current binary bit value to be driven by corresponding ones of drivers 195a-x. In some variations of such embodiments, this storage of the last binary bit value may be timed (or otherwise coordinated) with the aid of clock signal CLK received along with binary data bits Da-x. In other variations of such embodiments, this storage of the last binary bit value may be carried out through detection of a change from between 0 and 1 binary values without the aid of a clock signal. The storage of the last binary bit value and the comparison of that last binary bit value to the current binary bit value to be driven is carried out to determine when one of controllers 190a-x should signal a corresponding one of drivers 195a-x to reduce the strength with which that one of drivers 195a-x drives either a high or low voltage level on to a corresponding one of conductors 120. More specifically, where a given one of controllers 190a-x detects that the previous binary bit value matches the current binary bit value to be driven by the corresponding one of drivers 195a-x, such that the corresponding one of drivers 195a-x will essentially continue driving substantially the same voltage level onto the corresponding one of conductors 120, that given one of controllers 190a-x may signal that corresponding one of drivers 195a-x to reduce or “de-emphasize” the strength with which that one of drivers 195a-x drives continues to drive that same voltage level. As a result, a higher drive strength is used to drive a given voltage level onto one of conductors 120 when that voltage level is substantially different from the last voltage level driven, and a reduced, or de-emphasized, drive strength is used to drive a given voltage level onto one of conductors 120 when that voltage level is substantially the same voltage level as was already being driven. In this way, greater drive strength is used where it is more beneficial in overcoming a high capacitive load on a given one of conductors 120 to more quickly change a voltage level, while a lesser drive strength is used to maintain a voltage level where the desired voltage level is already being driven.

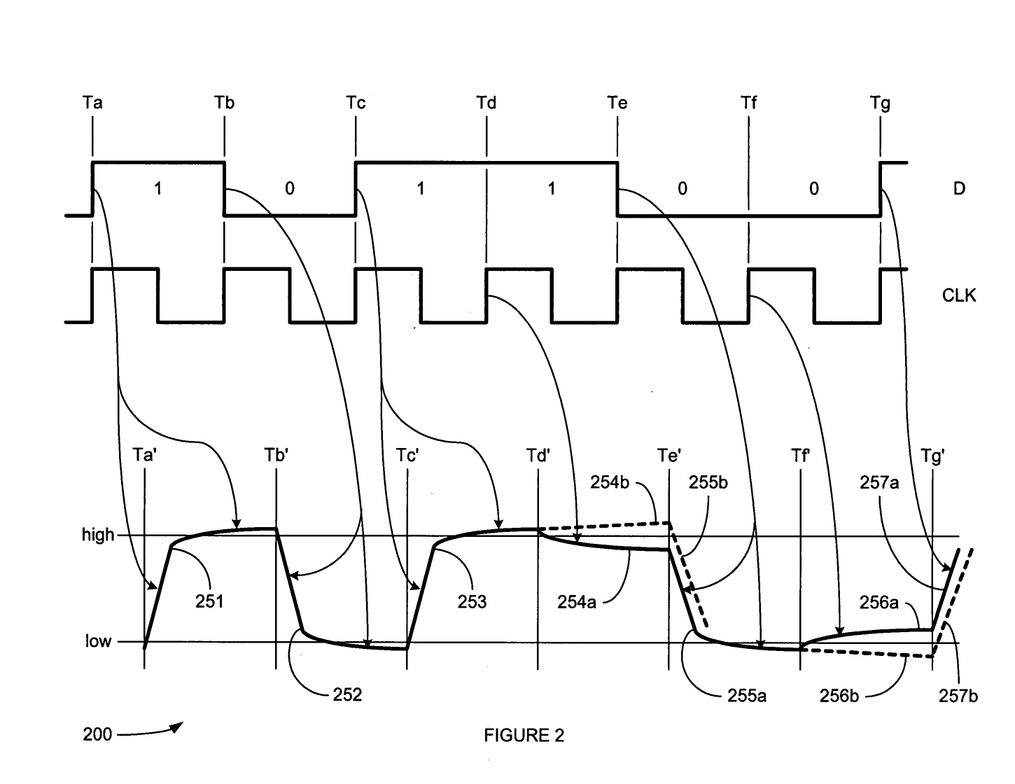

FIG. 2 is a timing diagram of embodiments employing de-emphasis of the strength with which one or the other of two voltage levels is driven. More precisely, FIG. 2 depicts correlations between sequences of binary bit values received by a driver device (such as one of driver devices 180a-x) and changes in voltage levels driven by such a driver device incorporated into a transmitting device (such as transmitting device 110) and received by a receiving device (such as either one of receiving devices 130a or 130b) from across a conductor (such as one of conductors 120) over time. The receipt by a driver device of various binary bit values from timepoint Ta to Tg each causes the occurrence of different portions of signal 200 from timepoint Ta′ to Tg′ transmitted by a transmitting device and received by a receiving device at a given point along the conductor carrying signal 200. It should be noted for the sake of clarity, that given the inevitable delay that occurs as signals propagate through any electronic device, including the various possible embodiments of driver device described herein, it is assumed that correlated ones of timepoints Ta to Tg and timepoints Ta′ to Tg′ are generally shifted by an interval of time relative to each other so that, for example, timepoint Ta′ is assumed to occur at some small interval of time after timepoint Ta, and so on for timepoints Tb′ relative to Tb, Tc′ relative to Tc, etc.

Starting with timepoint Ta, after having received a binary bit value of 0, a driver device receives a binary bit value of 1 to be transmitted across a conductor. After an interval of delay, the receipt of the binary bit value of 1 brings about a change at timepoint Ta′ from driving the conductor to a lower voltage level to driving the conductor to a higher voltage level, thereby resulting in the climbing of the voltage level as encountered by a receiving device to a higher voltage level depicted by signal segment 251. At timepoint Tb, the driver device receives a binary bit value of 0 to be transmitted, and this brings about a change starting at timepoint Tb′ from driving the conductor to a higher voltage level to driving the conductor to a lower voltage level, thereby resulting in the falling of the voltage level depicted by signal segment 252. The climbing voltage level activity depicted by signal segment 251 reoccurs with signal segment 253, starting at timepoint Tc′ in response to the receipt of a binary bit value of 1 at timepoint Tc. However, while the binary bit value of 1 received at timepoint Ta was followed immediately thereafter by a binary bit value of 0 received at timepoint Tb, the binary bit value of 1 received at timepoint Tc is followed by another binary bit value of 1 received at timepoint Td. This occurrence of back-to-back binary bit values of 1 results in the occurrence of signal segment 254a starting at timepoint Td′, though as will shortly be discussed, an alternate signal segment 254b (shown with a dotted line) could have resulted. In a manner not unlike the receipt of a binary value of 0 at timepoint Tb, the receipt of a binary bit value of 0 at timepoint Te, following the aforementioned back-to-back binary bit values of 1, brings about a falling of the voltage level as depicted by signal segment 255a, though as will be discussed, had the activity depicted by alternate signal segment 254b occurred, then the voltage level activity depicted starting at timepoint Te′ with alternate signal segment 255b would have occurred, instead. At timepoint Tf, another binary bit value of 0 is received, bringing about an instance of back-to-back binary bit values of 0, thereby resulting in the occurrence of signal segment 256a starting at time point Tf′, though as will be shortly discussed, an alternate signal segment 256b (shown with a dotted line) could have resulted. Finally, at timepoint Tg, a binary bit value of 1 is received, resulting in the occurrence of signal segment 257a starting at timepoint Tg′, though again, as will be explained shortly, had signal segment 256b occurred, instead of signal segment 256a, signal segment 257b would occur starting at timepoint Tg′, instead of signal segment 257a.

As just described, starting at timepoint Td′, there are instances along signal 200 where more than one signal segment could have resulted from the receipt of the various binary bit values starting at timepoint Td. What separates signal segments 254a and 255a from signal segments 254b and 255b, and what separates signal segments 256a and 257a from signal segments 256b and 257b is a reduction (or “de-emphasis”) in drive strength implemented between timepoints Td′ and Te′, and between timepoints Tf′ and Tg′ as a result of the corresponding occurrences of back-to-back binary bit values of 1 and back-to-back binary bit values of 0. More precisely, where a given binary bit value is received at one timepoint followed the receipt of an identical binary bit value at the very next timepoint, the receipt of both of the identical binary values results in substantially the same voltage level being driven onto the conductor, but the receipt of the second one of the identical binary bit values triggers a reduction in the drive strength with which the driver device continues to drive that voltage level. This is done partly in recognition of the need for a higher drive strength to change the conductor from one voltage level to another relatively quickly, and a corresponding lack of necessity to continue to drive a given voltage level at the such a higher drive strength to simply maintain a similar voltage level.

In the case of the differences between signal segments 254a and 255a and signal segments 254b and 255b, signal segment 254a shows the more immediate effect of the lowering of the strength with which a high voltage level is driven onto the conductor as encountered at the point at which a receiving device is coupled to the conductor, while signal segment 254b shows the more immediate effect of maintaining the same drive strength with which the transition from a lower voltage level to a higher voltage level was achieved, as depicted by signal segment 253. Due to the capacitive load to which the conductor is subjected from any of a number of various sources, as those skilled in the art will readily recognize, a relatively increased level of drive strength is needed to overcome the capacitive load, which tends to hold the conductor to its current voltage level and thereby resist efforts to change it. Such a greater drive strength may be used to cause the transition from a lower voltage level to a higher voltage level to occur relatively quickly, thereby avoiding wasting valuable time in bringing about this transition, and thereby allowing more time for the new voltage level to settle and be accurately received and read by the receiving device. However, were that same greater drive strength to be maintained beyond timepoint Td′ as a result of the receipt of a second binary bit value of 1 at timepoint Td, then as signal segment 254b depicts, the voltage level would continue to rise as the capacitive load actually causes the buildup of an ever higher voltage level charge on along the conductor. This ever higher voltage level charge is unnecessary to ensuring the accurate receipt and reading of the ever higher voltage level by the receiving device, and is therefore, wasteful of electrical energy. This waste of energy can have other consequences, especially in device where minimizing power consumption by components is a concern (as in the case of a battery-powered device), or minimizing heat dissipation by components is a concern (as in the case of very devices where either the physical room or available power to support the removal of heat is limited, as in the case of a portable computer, densely packed server computers, or network appliance). Especially in electronic systems where a great number of driver devices are employed, the reduction in power consumption and heat dissipation may be such as to significantly impact the overall physical size of the electronic system, as a result of the opportunity created by power savings for the number and/or size of power supply and/or heat dissipation components to be reduced. However, beyond simply wasting energy, the ever higher voltage level to which the conductor has been capacitively charged requires more energy at timepoint Te′ to overcome resulting in the fall of the voltage level to a lower voltage level to take longer to occur, as depicted by signal segment 255b. This longer period of time required for this fall to a lower voltage level leaves less time for the receiving device to accurately receive and read the lower voltage level.

Similar circumstances define the differences between signal segments 256a and 257a, and signal segments 256b and 257b. A greater drive strength is needed to overcome an existing capacitively supported higher voltage level and drive the voltage level down to a lower voltage level starting at timepoint Te′, than is needed to maintain a lower voltage level starting at timepoint Tf′ as a result of the receipt of a second one of a pair of back-to-back binary bit values of 0 at timepoint Tf. Signal segment 256a depicts immediate results of reducing (or “de-emphasizing”) the drive strength with which the lower voltage level is driven starting at timepoint Tf′, while signal segment 256b depicts the immediate results of continuing to drive the lower voltage level with the same greater drive strength. Not unlike the case depicted between timepoints Td′ and Te′, the combination of the capacitive load to which the conductor is subjected and the greater drive strength causes the voltage level to continue to fall to an ever lower voltage level as a greater negative charge is capacitively stored, and this ever lower voltage level, just like the aforedescribed ever higher voltage level, represents an unnecessarily wasteful expenditure of energy to bring about. Also, not unlike what is discussed with regard to overcoming the aforedescribed ever higher voltage level, more energy and more time is required to overcome the ever lower voltage level when a transition from the ever lower voltage level is triggered starting at timepoint Tg′, as depicted by signal segment 257b.

FIG. 2 also depicts a clock signal received by the driver circuit alongside the aforementioned binary bit values of 0 and 1. Although the rising edge of the clock cycles of the depicted clock are shown as being coincident to the rising and falling edges of changes between binary bit values of 0 and 1, those skilled in the art will readily appreciate that the choice of which phase of the depicted clock is in alignment with such changes in binary bit values is immaterial to practice of the claimed invention. In a manner analogous to the driver circuits 180a-x depicted in FIGS. 1a-b, in various possible embodiments, whatever driver circuit that may drive signal 200 onto a conductor may or may not make use of such a clock signal in storing a previous binary bit value for comparison to a current binary bit value to be driven by the driver circuit. Furthermore, in still other possible embodiments, there may be no storage of binary bit values for purposes of making such a comparison, and instead, control circuitry within whatever driver circuit driving signal 200 may simply monitor the input by which binary bit values are received for instances of a change in binary bit values from 0 to 1 and from 1 to 0, and employ a delay line, timer, pulse generator, or other such circuitry to simply cause a momentary increase of the drive strength by which signal 200 is driven for a predetermined period of time immediately following an instance of a change in binary bit values to provide the greater drive strength needed to change signal 200 from a lower voltage level to a higher voltage level, or vice versa. In such other possible embodiments, the duration of this predetermined period of time may be set to closely match the length of time depicted between timepoints within FIG. 2, such that the resulting signal continues to substantially resemble that of signal 200, or the duration of this predetermined period of time may be chosen to be either shorter or longer than the length of time depicted between the timepoints, possibly with the aim of fine tuning the high and/or low voltage levels.

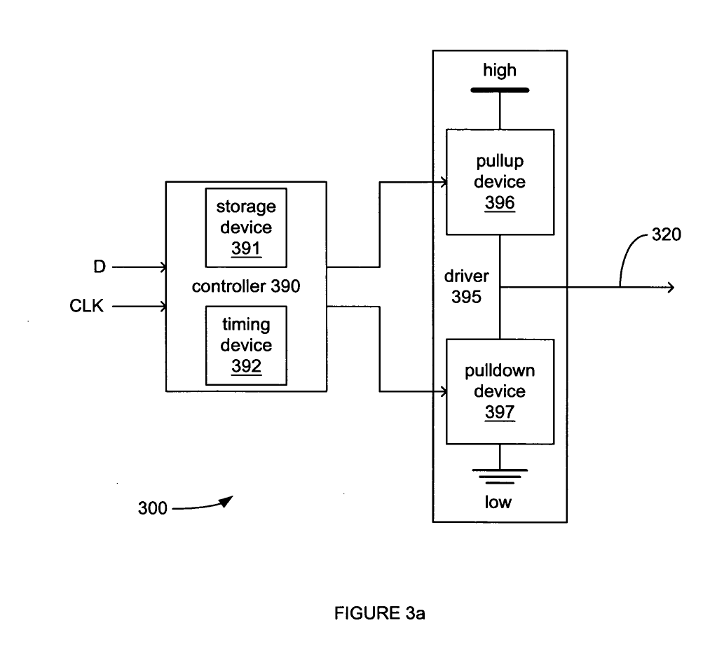

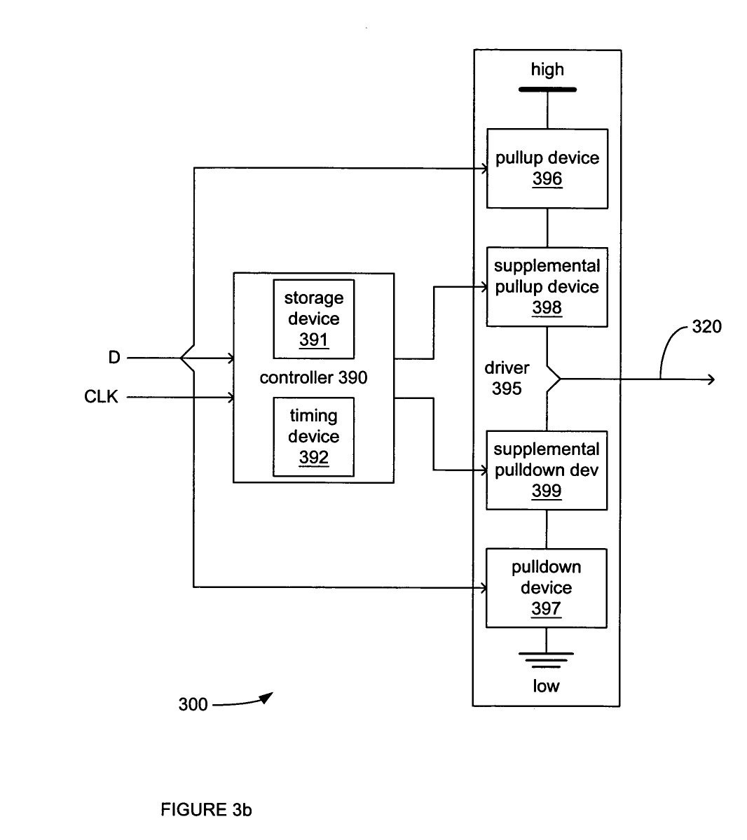

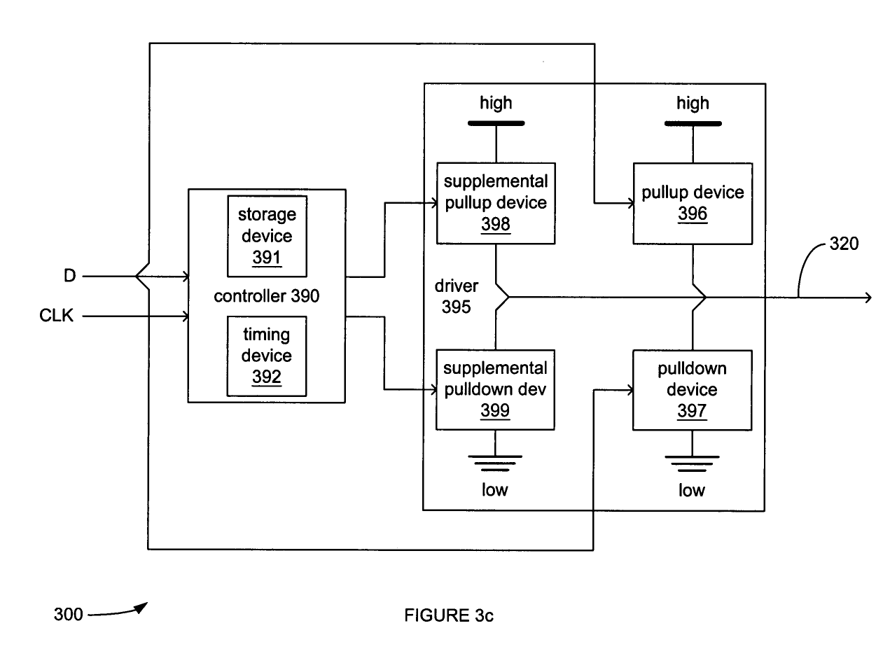

FIGS. 3a, 3b and 3c depict embodiments employing differing implementations of a driver circuit. More specifically, FIGS. 3a-c provide more detailed depictions of three different implementations of driver circuit 300 that each could be used the implementation of driver circuit employed as driver circuits 180a-x in FIG. 1, or that could be the driver circuit discussed as producing signal 200 in FIG. 2. It should be noted that this depiction of three different implementations of driver circuit 300 is intended to be illustrative of some possible implementations for purposes of further illuminating this discussion of the claimed invention, and should by no means be construed as in some way limiting the spirit and scope of the present invention as hereinafter claimed to any one implementation or any specific set of implementations.

Each of the three implementations of Driver circuit 300 depicted in FIGS. 3a-c, in a manner analogous to driver circuits 180a-x of FIG. 1, receive a binary data bit D to be driven as either a high or low voltage level by driver circuit 300 onto conductor 320 in a manner not unlike the driving the driving of a high or low voltage level onto corresponding ones of conductors 120. Also in a manner not unlike driver circuits 180a-x, each of the three depicted variants of driver circuit 300 may receive and make use of a clock signal CLK to time the storage of each bit of binary data received in order to store the last bit of binary data received and driven onto conductor 320 to be compared with the current bit of binary data to be driven onto conductor 320.

In all three variants of driver circuit 300, the actual driving of a high or low voltage level onto conductor 320 is carried out through the use of pullup device 396 and pulldown 397, respectively. As those skilled in the art will readily understand, the actual electronic component or components that make up each of pullup device 396 and pulldown device 397, and perhaps, may be as simple as a single transistor to make up each of pullup device 396 and pulldown device 397. However, as those skilled in the art will also readily recognize, there is a common practice to discuss and conceptualize drivers, such as pullup device 396 and pulldown device 397, as being pullup and pulldown resistors, respectively, with resistance levels that are in some way controllable as a kind of shorthand to facilitate such discussion and conceptualization, regardless of whether or not an actual resistor is employed in the design of either pullup device 396 or pulldown device 397.

In all three variants of driver circuit 300, controller 390 is depicted as being possibly made up, at least in part, of either storage device 391 or timing device 392. As already discussed, in some embodiments of a driver circuit (such as the three depicted variants of driver circuit 300), a storage device (such as storage device 391) may be employed to store whether or not the last binary bit value received for being driven onto conductor 320 was a value of 0 or a value 1 in order for comparison against the current binary bit value to determine if the current binary bit value is the same as or different from the last binary bit value as a way of determining whether or not to a greater drive strength is required to change the voltage level to which conductor 320 is being driven, or to reduce the drive strength to simply maintain the voltage level to which conductor 320 is already being driven. However, as also previously discussed, other embodiments of a driver circuit (such as the three depicted variants of driver circuit 300) may not actually store the last binary bit value received, and instead, may monitor the signal by which binary bit values are provided for occurrences of a change from a binary bit value of 0 to 1, or vice versa, and use such occurrences of a change as a trigger to momentarily cause a greater drive strength to be employed in driving conductor 320 as an aid to bringing about a speedier change in corresponding voltage levels by aiding in the overcoming of capacitive effects on exerted on conductor 320 that tend to cause conductor 320 to maintain a voltage level already earlier driven onto conductor 320. This momentary increase in drive strength would then be discontinued after a predetermined period of time such that the new voltage level driven onto conductor 320 would be maintained with a lesser drive strength, especially if the next binary bit value proves to be the same as the binary bit value involved in triggering the change in voltage levels just made.

In the variant of driver circuit 300 depicted in FIG. 3a, pullup device 396 and pulldown device 397 are entirely under the control of controller 390, which receives binary bit values to be driven onto conductor 320 by pullup device 396 and pulldown device 397. Regardless of the specific mechanism used to do so, controller 390 monitors the incoming binary bit values to determine what voltage level is to be driven onto conductor 320 and with how much drive strength. If the last binary bit value received was 0 and the current value is also 0, then controller 390 causes pulldown device 397 to continue driving a lower voltage level onto conductor 320, but with a drive strength that is less than the drive strength that would have been employed, earlier, to change the voltage level on conductor 320 from a higher voltage level to the lower voltage level. Similarly, if the last binary bit value received was 1 and the current value is 1, then controller 390 causes pullup device 396 to continue driving a higher voltage level onto conductor 320, but with a lesser drive strength than would be employed to change from a lower voltage level to a higher voltage level. However, if the last binary bit value received was 0 and the current value is 1, then controller 390 causes pulldown device 397 to cease driving a lower voltage level onto conductor 320 and also causes pullup device 396 to drive a higher voltage level onto conductor 320 with a drive strength that is greater than what controller 390 may subsequently cause pullup device 396 to use to maintain the higher voltage level. Similarly, if the last binary bit value received was 1 and the current value is 0, then controller 390 causes pullup device 396 to cease driving a higher voltage level and causes pulldown device 397 to employ a greater drive strength to drive a lower voltage level onto conductor 320 than what may be subsequently used to maintain a lower voltage level.

The variant of driver circuit 300 depicted in FIG. 3b differs from that depicted in FIG. 3a, principally in the fact that pullup devices 396 and pulldown device 397 receive their signals controlling their activities from a direct coupling to the signal by which binary bit values are received, alongside controller 390. Therefore, whether or not a high or low voltage level is driven onto conductor 320 by pullup device 396 or pulldown device 397, respectively, is directly controlled by the received bit value, and not indirectly through controller 390. Instead, controller 390 controls only the amount of drive strength employed in driving either a lower or higher voltage level onto conductor 320, and controller 390 does so by controlling supplemental pullup device 398 wired in series with pullup device 396, and by controlling supplemental pulldown device 399 wired in series with pulldown device 397. If the last binary bit value received was a 0 and the current value is also 0, then pulldown device 397 is already acting to drive a lower voltage level onto conductor 320, however, controller 390 causes supplemental pulldown device 399 to increase resistance such that the drive strength employed by pulldown device 397 to drive that lower voltage level onto conductor 320 is effectively reduced. Similarly, if the last binary bit value received was a 1 and the current value is also 1, then pullup device 396 is already driving a higher voltage level onto conductor 320, but controller 390 causes supplemental pullup device 398 to increase resistance to reduce the effective strength at which that higher voltage level continues to be driven.

The variant of driver circuit 300 depicted in FIG. 3c is quite similar in operation to that depicted in FIG. 3b, except that supplemental pullup device 398 and supplemental pulldown device 399 are wired in parallel with pullup device 396 and pulldown device 397, respectively. As a result, increasing or reducing the drive strength employed in driving a higher or lower voltage levels onto conductor 320 is effected through using supplemental pullup device 398 and supplemental pulldown device 399 to augment (i.e., increase, rather than reduce) the drive strengths by which the higher and lower voltage levels are driven.

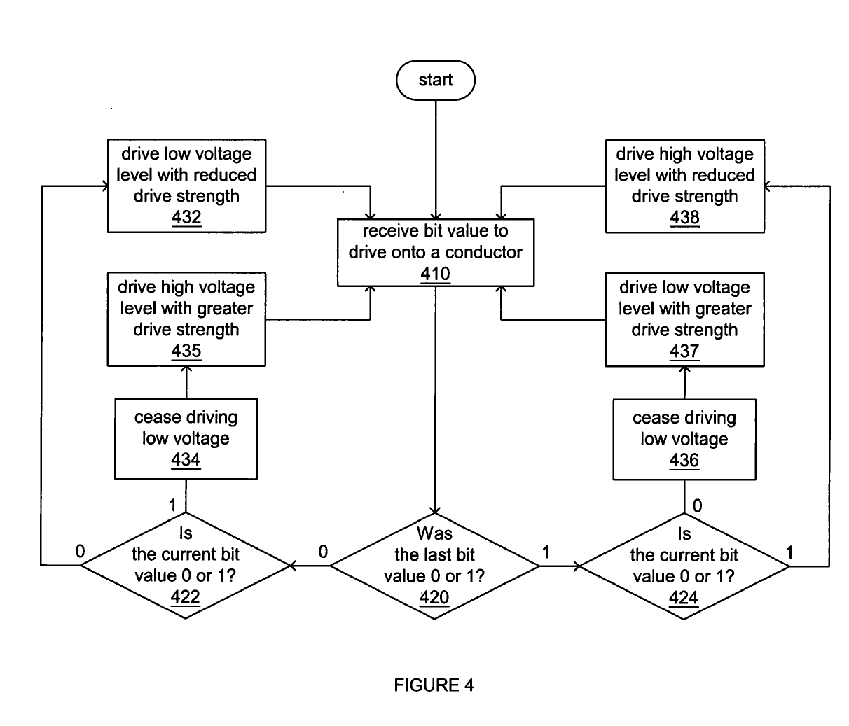

FIG. 4 is a flow chart of embodiments in which the drive strength by which a given voltage level is driven onto a conductor is varied. Starting at 410, a binary bit value is received by a driver circuit from another circuitry to which the driver circuit is coupled or of which the driver circuit is a part. At 420, a check is made as to whether or the last binary bit value was a 0 or a 1. If the last binary bit value was a 0, then a check is made at 422 as to whether the current binary bit value (i.e., the binary bit value just received) is a 0 or 1, and alternatively, if the last binary bit value was a 1, then a check is made at 422 as to whether the current binary bit value is a 0 or 1. If, at 422, the current binary bit value is 0, then at 432, the current lower voltage level already being driven onto a conductor by the driver circuit as a result of the last binary bit value being 0 continues to be driven onto the conductor, but with a reduced drive strength. However, if at 422, the current binary bit value is 1, then at 434, the driver circuit ceases to drive a lower voltage onto the conductor and begins driving a higher voltage with a greater drive strength onto the conductor at 435. Similarly, if at 424, the current binary bit value is 1, then at 438, the current higher voltage level already being driven onto the conductor as a result of the last binary bit value being 1 continues to be driven onto the conductor, but with a reduced drive strength. However, if at 424, the current binary bit value is 0, then at 436, the driver circuit ceases to drive a higher voltage onto the conductor and begins driving a lower voltage with a greater drive strength onto the conductor at 437.

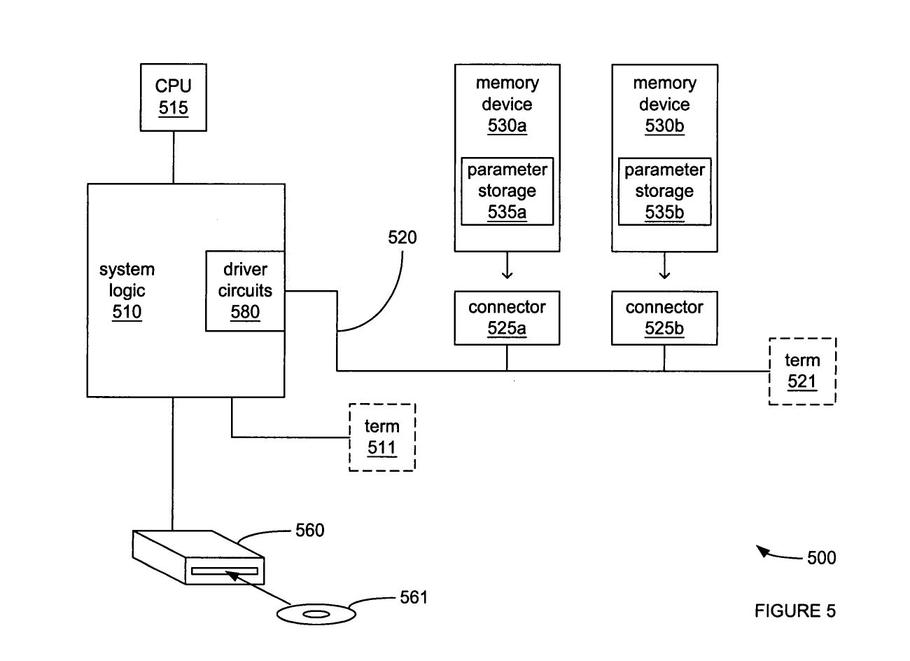

FIG. 5 is a block diagram of one embodiment employing a computer system. Computer system 500 is, at least in part, made up of processor 516, memory controller 511 and memory devices 530a and/or 530b. Together, processor 516, memory controller 511 and memory devices 530a and/or 530b make up a form of core for computer system 500 capable of supporting the execution of machine readable instructions by processor 516 and the storage of data, including instructions, within memory devices 530a and/or 530b. As depicted in FIG. 5, in some embodiments, memory controller 511 is coupled to processor 516 through being incorporated into system logic 510, which in addition to supplying the way by which processor 516 and memory controller 511 are coupled, may also carry out various other functions in support of processor 516 (e.g., by providing timers, I/O interfaces, DMA controllers, interrupt controllers, etc.). However, in alternate embodiments, memory controller 511 may be coupled to processor 516 in any of a number of ways, and may even be incorporated into processor 516. Also as depicted, and as will be explained in greater detail to follow, memory controller 511 is coupled to memory devices 530a and/or 530b through at least driver circuits 580 and conductors 520.

In various embodiments, processor 516 could be any of a variety of types of processor including a processor capable of executing at least a portion of the widely known and used “x86” instruction set, and in other various embodiments, there could be more than one processor. Furthermore, processor 516 may possess either one or more than one processor cores such that processor 516 is able to execute multiple independent sets of machine-readable instructions in parallel.

In various embodiments, memory devices 530a and 530b could be made up of one or more memory devices of any of a variety of types of DRAM including (but not limited to) fast page mode (FPM), extended data out (EDO), single data rate (SDR) or double data rate (DDR) forms of synchronous dynamic RAM (SDRAM), RAM of various technologies employing a RAMBUS™ interface, etc. Memory controller 511, at least in part through driver circuits 580 and conductors 520, provides an appropriate interface for memory devices 530a and 530b, regardless of DRAM type. In some embodiments, memory devices 530a and 530b may be a removable modules, such as a single inline memory module (SIMM), dual inline memory module (DIMM), single inline pin package (SIPP), etc., implemented in the form of a substrate, such as a small circuit board, on which are mounted one or more memory ICs (integrate circuits). In such embodiments, memory device 530a and 530b would be electrically coupled to conductors 520 (and through conductors 520, be coupled in turn to at least driver circuits 580) through connectors 525a and 525b, respectively. In other embodiments, memory devices 530a and 530b may be made up of one or more memory ICs mounted directly to the same larger circuit board on which processor 516 and/or memory controller 511 (or perhaps a form of system logic 510 or processor 516 incorporating memory controller 511) are also mounted, and such other embodiments, connectors 525a and 525b may not be present.

Memory controller 511 transmits address, command and/or data signals to memory devices 530a and/or 530b through driver circuits 580 onto at least some of conductors 520, which in a manner consistent with the above discussion concerning such driver circuits as 180a-x and 530, alter the drive strength used in carrying out such transmissions onto conductors 520, depending on absence or occurrence of changes in binary bit values of bits making up addresses, commands and/or data. More specifically, and as an example, where memory controller 511 employs driver circuits 580 to transmit data to one or the other of memory devices 530a and 530b, each conductor out of conductors 520 that is to be driven with data is so driven by a separate driver circuit within driver circuits 580, and each of these driver circuits will drive a voltage level representing a bit of data onto the corresponding one of conductors 520 with more or less drive strength, depending on whether or not each new bit to be transmitted is of a different value or of the same value as the one transmitted immediately before. Where a new bit received by any one of these driver circuits has a binary value that differs from the bit immediately preceding it such that the voltage level being driven by that driver must change in order to represent the new bit value, that driver will drive the new voltage level onto its corresponding conductor with a greater drive strength, and where a new bit received by that drive circuit is of the same binary value as the last bit such that the voltage level being driven is to be maintained in order to represent the new bit value, that driver will continue to drive the same voltage level onto its corresponding conductor, but with a lesser drive strength in comparison to the drive strength used to change the voltage level.

The use of driver circuits 580 by memory controller 511 to drive at least some of the conductors of conductors 520 may be in answer to increased capacitive loads placed on conductors 520 by the coupling of multiple memory devices (such as both memory devices 530a and 530b) to conductors 520, and/or may be in answer to increased capacitive loads placed on conductors through the use of connectors (such as connectors 525a and 525b) as a way of allowing memory devices (such as memory devices 530a and 530b) or other devices to be removable. Capacitive loads may also be increased by other factors, as those skilled in the art will recognize, such as at least some of conductors 520 being relatively lengthy, the physical cross section of conductors 520, the choice of materials used to create conductors 520, the type of transmission line configuration of conductors 520, the dielectric characteristics of other materials in the immediate vicinity of conductors (including PCB material or insulators for conductors 520), the use of terminators (such as terminator 521) on at least some of conductors 520, etc.

In some embodiments, given that some of these sources of capacitive load may be removable, and therefore, not consistently present (such as one or the other of memory devices 530a and 530b being removable as by using one or both of connectors 525a and 525b, respectively, to couple memory devices 530a and 530b to conductors 520), such use of multiple levels of drive strength by driver circuits 580, or the level(s) of drive strength applied by driver circuits 580, may be programmable to allow alterations in response to changes in the capacitive load. In support of such programmability, memory controller 511 and/or driver circuits 580 may incorporate registers allowing such variations in drive strength to be enabled or disabled, or perhaps, to allow the degree of variation in drive strengths to be adjustable. Also in support of such programmability, memory devices 530a and/or 530b may provide one or more parameters readable from parameter storages 535a and/or 535b, respectively, that aid in determining whether or not to employ variations in drive strength and/or the degree of those variations. In other embodiments, the provision of a mechanism by which the presence or absence of one or both of memory devices 530a and 530b may be detected so as to be able to determine which one(s) of memory devices 530a and 530b are actually coupled to conductors 520 may be used in determining whether or not to employ variations in drive strength and/or the degree of those variations. As is further depicted in FIG. 5, computer system 500 may be further made up of removable media device 560 provide access to the contents of removable media 561, and/or parameter storage 515. In some embodiments, support for programmability of drive strength variations may be further aided by the provision of parameters or other characteristics of either computer system 500, or one or both of memory devices 530a and 530b by one or both of parameter storage 515 and removable media 561.

The invention has been described in conjunction with various possible embodiments. It is evident that numerous alternatives, modifications, variations and uses will be apparent to those skilled in the art in light of the foregoing description. It will be understood by those skilled in the art that the present invention may be practiced in support of various types of electronic systems employing conductors and driver circuits for purposes other than transmission of signals to memory devices, as in the case of general purpose buses used in communications with I/O devices. It will also be understood by those skilled in the art that the present invention may be practiced in support of electronic systems other than computer systems such as audio/video entertainment devices, controller devices in vehicles, appliances controlled by electronic circuitry, etc.

What is claimed is:

1. An apparatus comprising:
at least one conductor;
a receiving device coupled to the at least one conductor to receive a signal from the at least one conductor; and
a transmitting device having at least one driver circuit coupled to the at least one conductor to transmit binary bits of data provided by the transmitting device as a signals across the conductor to the receiving device, wherein the at least one driver circuit transmits a first voltage level with a first drive strength if the value of a current binary bit of data differs from the value of the previous binary bit of data, and wherein the at least one driver circuit transmits the first voltage level with a second drive strength that is a lesser drive strength than the first drive strength if the value of the current binary bit of data is the same as the value of the previous binary bit of data.

2. The apparatus of claim 1, wherein the at least one conductor is one of a plurality of conductors comprising a bus across which binary data is transmitted from the transmitting device to the receiving device.

3. The apparatus of claim 2, wherein each conductor of the plurality of conductors is comprised of a conductive trace of printed circuit board.

4. The apparatus of claim 1, wherein the transmitting device is comprised of a memory controller and wherein the receiving device is a memory device to store data.

5. The apparatus of claim 1, wherein the at least one driver circuit is comprised of a controller to monitor the binary bits of data provided by the transmitting device for occurrences of two consecutive bits of binary to be transmitted by the at least one driver circuit that are of the same value.

6. The apparatus of claim 5, wherein the controller is comprised of a storage device to store the value of the previous bit of binary data to facilitate comparison with the value of the current bit of binary data to determine whether to drive the first voltage level with the first drive strength or the second drive strength.

7. The apparatus of claim 5, wherein the controller is comprised of a timing device responsive to an occurrence of a change in value between two adjacent bits of binary data to cause the first voltage level to be driven with the first drive strength for a predetermined period of time and to then cause the first voltage level to be driven with the second drive strength after the predetermined period of time has elapsed.

8. A method of transmitting a signal comprising:
sequentially receiving a plurality binary bit values to drive onto a conductor by a driver circuit coupled to the conductor;
ceasing driving one of two voltage levels representing an immediately preceding binary bit value onto the conductor and driving the other of the two voltage levels representing a current binary bit value onto the conductor with a high drive strength if the current binary bit value differs from the immediately preceding binary bit value; and
continuing to drive a voltage level representing an immediately preceding binary bit value is driven onto the conductor with a low drive strength to represent the current binary bit value if the current binary bit value is the same as the immediately preceding binary bit value.

9. The method of claim 8, further comprising storing the immediately preceding binary bit value within the driver circuit for comparison with the current binary bit value.

10. The method of claim 8, wherein a binary bit value of 1 to be transmitted is represented by driving a high voltage level onto the conductor, and a binary bit value of 0 to be transmitted is represented by driving a low voltage level onto the conductor.

11. The method of claim 10, further comprising:
ceasing to drive a low voltage level onto the conductor and driving a high voltage level onto the conductor with the high drive strength if the immediately preceding binary bit value is 0 and the current binary bit value is 1;
continuing to drive a low voltage level onto the conductor with a low drive strength if the both the immediately preceding binary bit value and the current binary bit value are 0;
ceasing to drive a high voltage level onto the conductor and driving a low voltage level onto the conductor with the high drive strength if the immediately preceding binary bit value is 1 and the current binary bit value is 0; and
continuing to drive a high voltage level onto the conductor with a low drive strength if the both the immediately preceding binary bit value and the current binary bit value are 1.

12. A method of transmitting a signal comprising:
sequentially receiving a plurality binary bit values to drive onto a conductor by a driver circuit coupled to the conductor;
ceasing driving one of two voltage levels representing an immediately preceding binary bit value onto the conductor and driving the other of the two voltage levels representing a current binary bit value onto the conductor with a high drive strength for a predetermined period of time and then reducing the drive strength by which the other of the two voltage levels is driven when the predetermined period of time has elapsed, if the current binary bit value differs from the immediately preceding binary bit value.

13. The method of claim 12, wherein a binary bit value of 1 to be transmitted is represented by driving a high voltage level onto the conductor, and a binary bit value of o to be transmitted is represented by driving a low voltage level onto the conductor.

14. The method of claim 13, further comprising:
ceasing to drive a low voltage level onto the conductor and driving a high voltage level onto the conductor with the high drive strength for the predetermined period of time and then reducing the drive strength with which the high voltage level is driven onto the conductor, if the immediately preceding binary bit value is 0 and the current binary bit value is 1; and
ceasing to drive a high voltage level onto the conductor and driving a low voltage level onto the conductor with the high drive strength for the predetermined period of time and then reducing the drive strength with which the low voltage level is driven onto the conductor, if the immediately preceding binary bit value is 1 and the current binary bit value is 0.
